(19) United States
(12) Patent Application Publication
(10) Pub. No.: US 2013/0331156 A1
(43) Pub. Date: Dec. 12, 2013

(54) BACK CASE FOR PORTABLE ELECTRONIC DEVICE

(71) Applicant: HON-MAN LUI, NEW TAIPEI CITY (TW)

(72) Inventor: HON-MAN LUI, NEW TAIPEI CITY (TW)

(73) Assignee: ASKEY COMPUTER CORP., (TW)

(21) Appl. No.: 13/592,379

(22) Filed: Aug. 23, 2012

(30) Foreign Application Priority Data
Jun. 7, 2012 (TW) 101120481

(51) Int. Cl. A45C 11/00; H04W 88/02

(52) U.S. Cl. 455/575.8; 206/38

(57) ABSTRACT

A back case for use with a portable electronic device has a connection element for electrical connection with the portable electronic device. The back case is characterized in that the back case has a back cover and a sidewall; the back case has a receiving space; the back cover has a plurality of holes; the holes are positioned proximate to an end side of the back cover; the portable electronic device is received in the receiving space provided by the back case; the holes provides a resilient deformation force for the back case, so as for the portable electronic device to be fixed in place by the sidewall. Due to the holes of the back case, the back case can be mounted on or dismounted from the portable electronic device easily.

### CROSS-REFERENCE TO RELATED APPLICATION

This non-provisional application claims priority under 35 U.S.C. §119(a) on Patent Application No(s). 101120481 filed in Taiwan, R.O.C. on Jun. 7, 2012, the entire contents of which are hereby incorporated by reference.

### FIELD OF TECHNOLOGY

The present invention is related to a back case, particularly to a back case for portable electronic device capable of being easily mounted on or dismounted from the portable electronic device.

### BACKGROUND

In recent years, Near Field Communication (NFC) is applied to broader and broader fields, such as prepaid cards for MRT, credit cards for small transaction and etc. Moreover, NFC is combined with a smart phone to be handier. The smart phone equipped with a NFC module is then allowed for wireless data exchange and transmission by means of an electronic device having the function of near field induction (such as, card reader, for example) directly. For instance, the function, such as Easy Card, credit card, electronic purse, Identification card, inductive taxi-hiring service and etc., may be combined with the smart phone, and APPs installed on the smart phone may be further used for data transmission with the NFC module.

However, the NFC module is not directly installed in all types of mobile phones. In conventional technology, a back case for mobile phone equipped with the NFC module and the smart phone are then combined, in such a way that the smart phone is provided with the function of NFC. Nevertheless, the back case for mobile phone is generally made of rigid material to avoid the breakage of the NFC module due to distortion provided by a user. As illustrated in FIG. 1, there is shown a back case for mobile phone 2 made of one single plastic material. The back case for mobile phone 2 is provided with a receiving space 6 for receiving the smart phone (not shown in the figure), and further provided with a connection element 8 to be electrically connected with the smart phone.

In conventional technology, although the drawback of possible breakage of the NFC module is solved, the back case for mobile phone 2 is not easy to be mounted on or dismounted from the smart phone, because the back case for mobile phone 2 is not easy to be deformed, owing to the more rigid material and the location of connection element 8, by the force exerted by a user when the smart phone and the back case for mobile phone 2 are mounted on or dismounted from each other.

Therefore, how to invent a back case for portable electronic device, which is allowed to not only provide an expanded function of NFC for the mobile phone, but also achieve the effect of easy mounting on or dismounting from the mobile phone, is what the present invention discloses desirably.

### SUMMARY

It is one object of the present invention to provide an above-mentioned back case for portable electronic device, in which the effect of easy mounting on or dismounting from the portable electronic device may be achieved.

For achieving above and other objects, the present invention provides a back case for portable electronic device provided with a connection element for electrical connection with the portable electronic device. The back case is characterized in that: the back case is provided with a back cover and a sidewall, the back case being further provided with a receiving space, and the back cover being provided with a plurality of holes positioned proximate to an end side of the back cover. The portable electronic device is received in the receiving space provided by the back case. A resilient deformation force is provided by the holes for the back case, such that the portable electronic device is fixed in place by means of the sidewall.

In comparison with the conventional technology, the present invention provides a back case for portable electronic device, in which the back case is allowed to be mounted on or dismounting from the portable electronic device readily.

### BRIEF DESCRIPTION OF THE DRAWINGS

FIG. 1 is a construction diagram of a conventional back case for mobile;

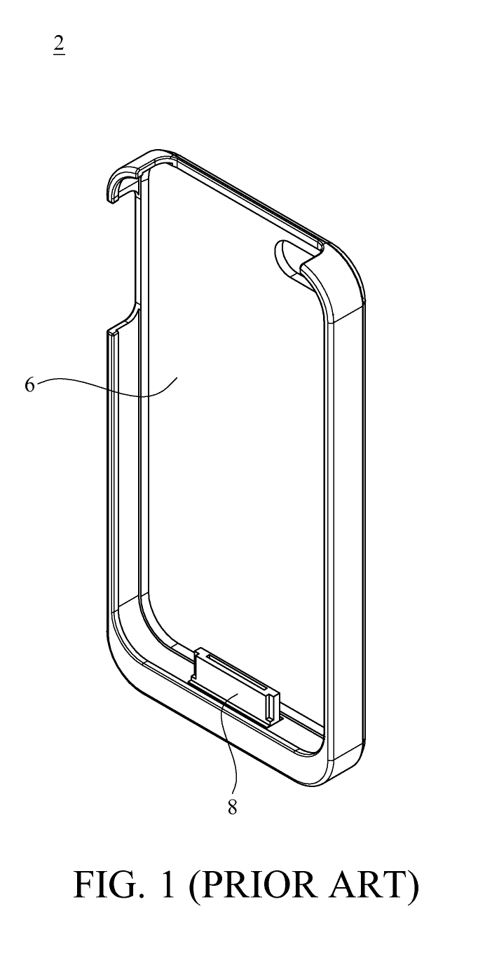

FIG. 2 is a construction diagram of a back case for portable electronic device according to one first embodiment of the present invention;

FIG. 3 is a construction diagram of a mobile phone illustrated in FIG. 2;

FIG. 4 is a side-view diagram of the back case for portable electronic device illustrated in FIG. 2 to which a force is applied;

FIG. 5 is a diagram showing the combination of the back case for portable electronic device illustrated in FIG. 2 and the mobile phone illustrated in FIG. 3;

FIG. 6 is a construction diagram of a back case for portable electronic device according to one second embodiment of the present invention; and

FIG. 7 is a construction diagram of a back case for portable electronic device according to one third embodiment of the present invention

### DETAILED DESCRIPTION

A detailed description will be made to the present invention by means of following embodiments in cooperation with accompanied drawings for fully understanding the objects, features and effects of the present invention.

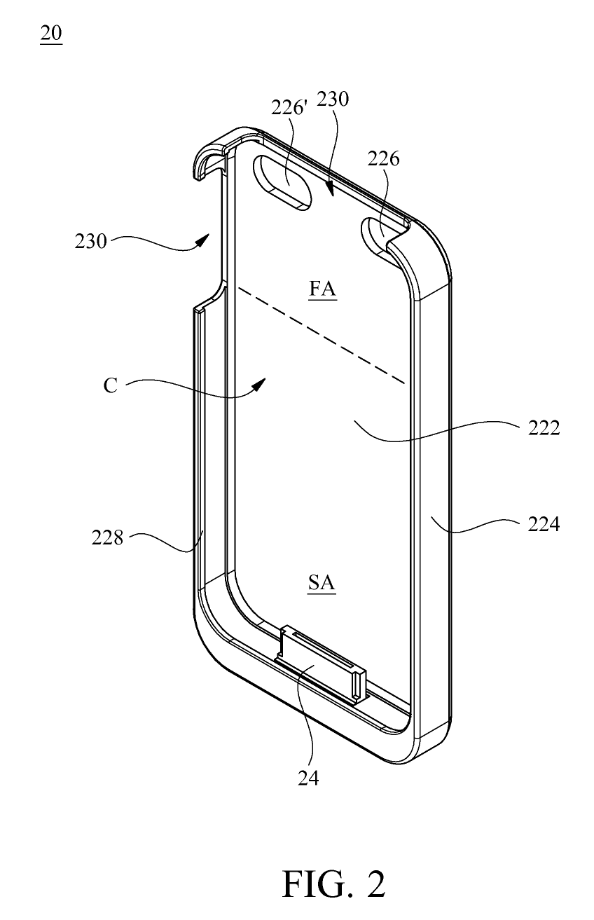

Referring to FIG. 2, there is shown a construction diagram of a back case for portable electronic device according to one first embodiment of the present invention. In FIG. 2, the back case for portable electronic device 20 is provided with a connection element 24, used for electrical connection with the portable electronic device (not shown in the figure). The back case 20 is characterized in that a back cover 222 and a sidewall 224 are provided. The back case 20 is further provided with a receiving space C. The sidewall 224 is extendingly provided around the periphery of the back cover 222. The receiving space C is defined by the back cover 222 and the sidewall 224. The receiving space C is provided for receiving the portable electronic device, and the back cover 222 is provided with a plurality of holes 226, 226′. The portable electronic device is received in the receiving space C provided by the back case 20, and the portable electronic device is fixed in place by means of the sidewall 224 by means of a resilient deformation force provided by the holes 226, 226′ for the back case 20.

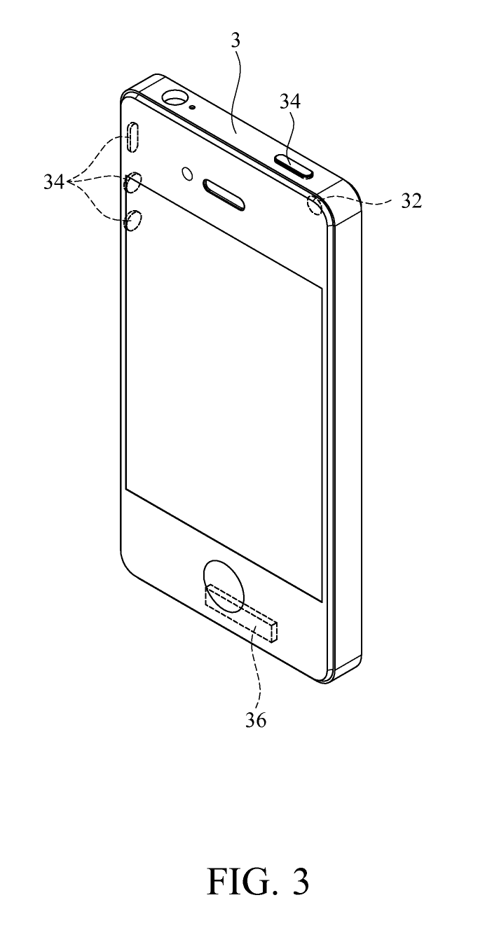

In this embodiment, a mobile phone 3 illustrated in FIG. 3 is taken as an example of the portable electronic device. The mobile phone 3, moreover, is provided with a camera lens 32, function keys 34 and a connection port 36, in which the camera lens 32 is provided on the back of the mobile phone 3, while the function keys 34 and the connection port 36 are provided on the side edge of the mobile phone 3.

Returning to FIG. 2, in this embodiment, an imaginary boundary line represented as a dotted line is used to further separate the back case 20 as a first area FA and a second area SA for the convenience of description of the back cover 222. In this case, the holes 226, 226′ are positioned in the first area FA and proximate to an end side of the back cover 222. For instance, the shape of the holes 226, 226′ may be circular, oval, capsular or other geometric figures. In this embodiment, the holes 226, 226′ are two in number and shaped as capsular, taken as an example. In this case, the position of the hole 226 may be corresponded to that of the camera lens 32 provided in the mobile phone 3, and the position of the connection element 24 is corresponded to that of the connection port 36 of the mobile phone 3.

Furthermore, the holes 226, 226′ are positioned in the first area FA, such that structural rigidity of the first area FA of the back case 20 is then changed, i.e., structural rigidity of a part of the back cover 222 near the end side of the back cover 222 in the first area FA is reduced, so as to raise an appropriate degree of resilient deformation of the back case 20 when the force is exerted by a user.

The sidewall 224, in the present embodiment, further comprises a fixing portion 228, provided in the sidewall 224 at one side opposite to the side where the case cover 222 is provided. In this case, when the mobile phone (not shown in the figure) is provided within the back case 20, the fixing portion 228 may be allowed to fasten the edge of the mobile phone, so as to further facilitate the sidewall 224 to clamp and fix the mobile phone within the receiving space C.

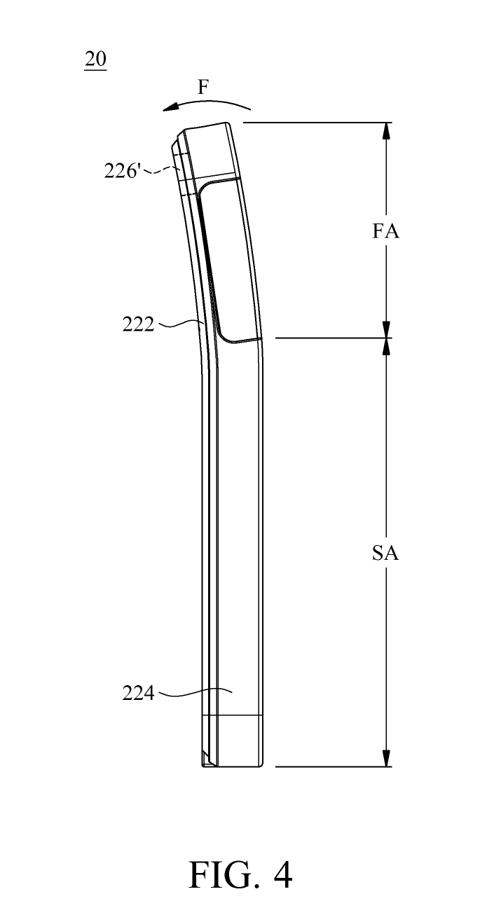

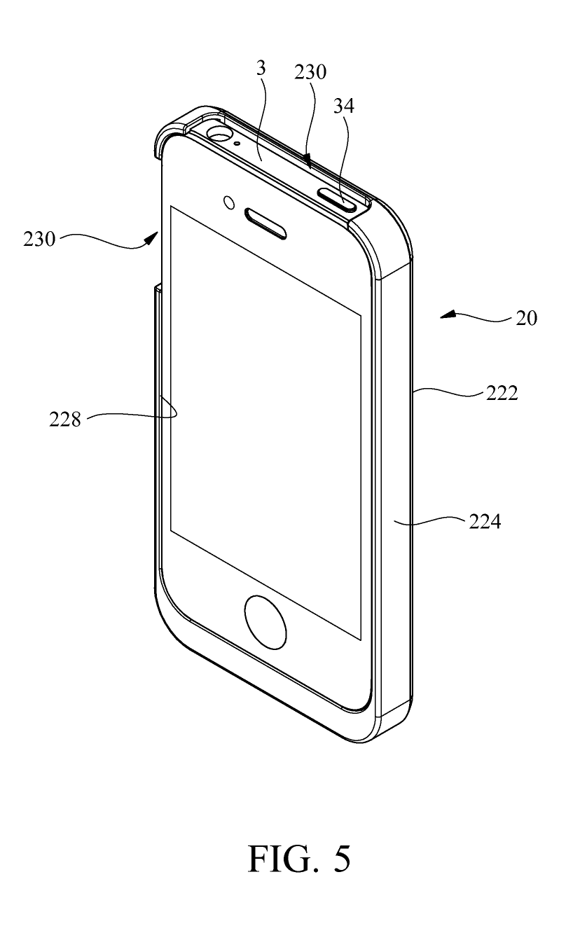

Referring to FIG. 4, together, there is shown a side-view diagram of the back case 20 shown in FIG. 2 to which a force is applied. In FIG. 4, when an action force F (such as vertical tension, torsion or bending) is exerted by a user on the first area FA of the back case 20, restorable extending deformation may occur in the first area FA of the back case 20, in such a way that the mobile phone 3 is provided within the back case 20 by means of the deformation. Moreover, the back case 20 may be restored to its undeformed shape after the action force F disappears, so as to fasteningly cover the mobile phone 3, namely, the side edge of the mobile phone 3 is fixed in place and pressed to be clamped by the sidewall 224, as illustrated in FIG. 5.

The sidewall 224 may further comprise indentations 230, in which locations where the indentations 230 are provided in the sidewall 224 are determined depending upon the positions of the function keys 34 of the mobile phone 3. When the mobile phone 3 is combined with the back case 20, the function keys 34 are appeared out of the indentations 230 to be operated by a user.

Furthermore, the back cover 222 and the sidewall 224 are presented as an integrated form (i.e., the exemplified form of this embodiment), and material used for the back cover 222 and the sidewall 224 may be plastic.

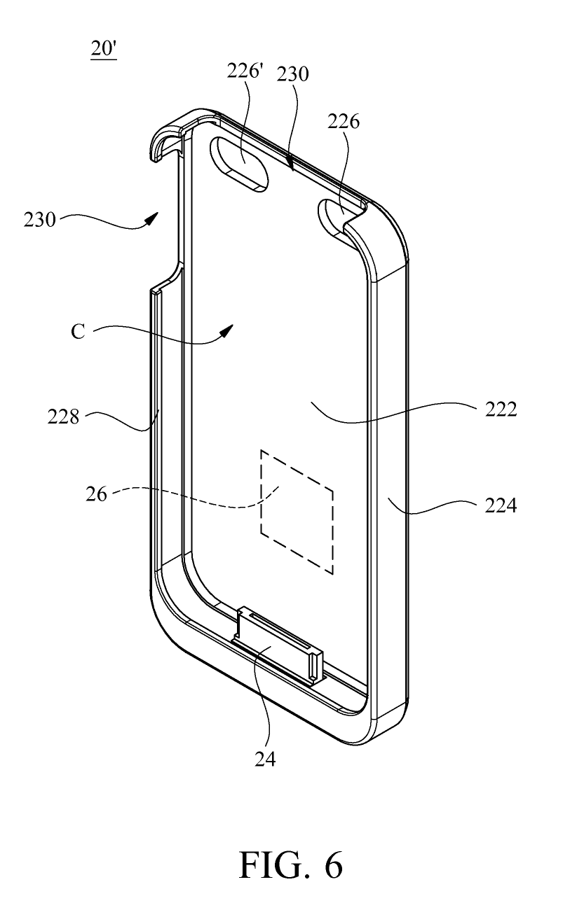

Referring to FIG. 6, there is shown a construction diagram of a back case for portable electronic device according to one second embodiment of the present invention. In FIG. 6, the back case for portable electronic device 20′ is provided with the connection element 24, the back cover 222 and the sidewall 224. Besides, the back case 20′, different from that in the first embodiment, further comprises a NFC module 26 within the case cover 222. Moreover, the NFC module 26 is connected with the connection element 24 through an electrical connection line (not shown in the figure), for example. Furthermore, when the mobile phone (not shown in the figure) is combined with the back case 20′, the connection port (not shown in the figure) provided at one end of the mobile phone is electrically connected with the connection element 24 of the back case 20′, such that near field data transmission may be obtained by the mobile phone through the NFC module 26. In this connection, the NFC module 26 further comprises a soft circuit board, antenna, NFC chip, security chip and etc. (not shown in the figure).

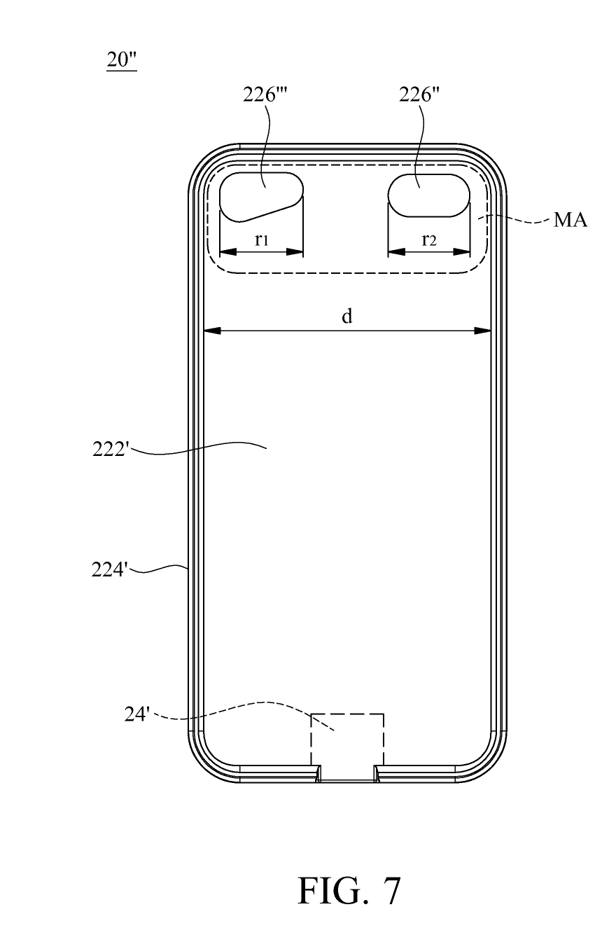

Referring to FIG. 7, there is shown a construction diagram of a back case for portable electronic device according to one third embodiment of the present invention. In FIG. 7, the back case for portable electronic device 20″ comprises a connection element 24′, a back cover 222′ and a sidewall 224′. The back cover 222′ is formed with a plurality of holes 226″, 226′″. In this connection, the holes 226″, 226″′ are symmetrically provided in the back case 222′, and proximate to an end side of the back cover 222′. If the sum of diameter r₁ of one of the holes 226″, 226″′ and diameter r₂ of another is smaller than two-thirds of width d of the back case 20″, the strength of structure of the back case 20″ may be assured without fracture caused by an exerted action force. Furthermore, the shapes of the holes 226″, 226″′ may be similar or dissimilar to each other. In this embodiment, dissimilar shapes of the holes 226″, 226″′ are exemplified, in which the hole 226″′ is presented in an irregular shape.

In this connection, a marked area MA is defined at one side, opposite to that mounted with the portable electronic device of the back case 20″. The marked area MA is proximate to the holes 226″, 226″′, and may be printed with symbols, signs and etc. (not shown in the figure) by means of printing or the like. Moreover, the locations of symbols and signs may be corresponded to the holes 226″, 226″′ of the back case 20″, so as to achieve the advertising effect.

Thus, the present invention provides a back case for portable electronic device, which may be mounted on or dismounted from the portable electronic device readily. Moreover, the portable electronic device may be readily expanded to obtain the function of NFC, after the back case and the portable electronic device are combined.

The present invention is disclosed by embodiments in foregoing description. However, it should be understood by those skilled in the art that the embodiments are merely used for describing the present invention and not considered as restrictive. It should be noted, that all equivalent variations and substitutions may be included within the scope of the present invention. Therefore, the present invention to be protected should be defined by appended claims.

What is claimed is:

1. A back case for a portable electronic device, provided with a connection element for electrical connection with said portable electronic device, characterized in that:
said back case is provided with a back cover and a sidewall, said back case being further provided with a receiving space, and said back cover being provided with a plurality of holes positioned proximate to an end side of said back cover; said portable electronic device being received in said receiving space provided by said back case; a resilient deformation force being provided by said holes for said back case, such that said portable electronic device is fixed in place by means of said sidewall.

2. The back case for portable electronic device according to claim 1, further comprising a Near Field Communication (NFC) module, provided within said case cover and electrically connected with said connection element.

3. The back case for portable electronic device according to claim 1, wherein the shape of said holes is circular, oval or capsular.

4. The back case for portable electronic device according to claim 1, wherein said sidewall further comprises indentations, and locations where said indentations are provided in said sidewall are determined depending upon the positions of function keys of said portable electronic device.

5. The back case for portable electronic device according to claim 1, wherein said back cover and said sidewall are presented as an integrated form.

6. The back case for portable electronic device according to claim 1, wherein said holes are symmetrically provided.
